(19) United States
(12) Patent Application Publication
(10) Pub. No.: US 2018/0069416 A1
(43) Pub. Date: Mar. 8, 2018

(54) Electric Bicycle Rental Outlet For Use In Off-Grid Locations

(71) Applicants: Michael Wayne Brace, St. Petersburg, FL (US); James William Moore, Papillion, NE (US)

(72) Inventors: Michael Wayne Brace, St. Petersburg, FL (US); James William Moore, Papillion, NE (US)

(21) Appl. No.: 15/260,232

(22) Filed: Sep. 8, 2016

(51) Int. Cl. H02J 7/00; H02J 7/35; B60L 11/18; B62H 3/00; B65D 88/12; H02S 10/12; H02S 10/40; H02S 40/38; F03D 9/00; F03D 9/25; H02K 7/18

(52) U.S. Cl. CPC H02J 7/0055; H02J 7/355; B60L 11/1824; B62H 3/00; B65D 88/121; H02S 10/12; B63B 25/004; H02S 40/38; F03D 9/002; F03D 9/25; H02K 7/183; B60L 2200/12; B62H 2003/005; H02S 10/40

(57) ABSTRACT

A wind and solar powered Light Electric Vehicle (LEV) rental outlet specifically configured to offer electric bicycles, SEGWAYS,

Personal mobility scooters and other such personal electric modes of transportation for rental in any remote, off-grid location served by the tourist industry, such as islands and beach resorts, and in other locations that typically do not have access to the electrical infrastructure to offer such a rental service. This LEV rental outlet is equipped with enough battery storage so as to allow for the multiple use of each personal electric vehicle on an hourly basis over the course of a day. The LEV rental outlet is configured entirely within an ISO Standard Shipping Container so as to be transportable on commercial container ship. This allows the LEV rental outlet it to be deployed and operated in any location in the world without the need of supporting infrastructure.

### FIELD

This invention relates to the field of commercial Light Electric Vehicle (LEV), more specifically a means to locate, charge and provide a fleet of electrically powered personal vehicles being offered for rent on a short-term basis in remote worldwide locations, locations typically without access to the electrical grid infrastructure needed to charge and operate a fleet of electrically powered personal vehicles from a rental outlet.

### BACKGROUND

Many cities are equipped with automatic systems for renting bicycles. These systems are typically set up with a number of bicycle rental/storage stations located in different parts of the city. Each station enables a customer to rent, pickup, and return a bicycle. U.S. Patent 20090240575 A1 Bicycle Rental System and Station details such a station. To allow for remote, off-grid locations the station in the aforementioned patent is solar powered so as to allow for electronic processing of the rental transaction. This aforementioned station, like most semi-automated bicycle rental stations, are equipped to only rent out manually powered bicycles. Conversely, if they are equipped with solar panels the solar panels are there to provide power to the rental processing unit and associated hardware for electronic transactions; not for the bicycles themselves.

The client base for manual bicycle and other personal mobility rentals tends to congregate in metropolitan areas and as such these manual bicycle rental stations are located in such areas. These manual bicycle rental stations are frequented by commuters that rent them either on a daily basis (in order to get to and from work) or to run the occasional errand. The client base for manual bicycle rentals tends to be more traditional, planned-out-ahead type of rental clients.

Light Electric Vehicles (LEVs), such as electrically powered bicycles, Segways, Personal Mobility Scooters and small electric 4-wheeled vehicles (such as a golf cart) rentals do not currently occupy a large segment of the rental industry but have established a niche market none the less. LEV rentals are typically offered through fixed locations from permanent structures that tend to be limited in size, scope and location. This is due to the fact that LEVs need a continuous source of electricity with which to charge the batteries used on the vehicles. Accordingly, these same electric vehicle rental outlets tend to be limited in customer availability due to location and the need for the infrastructure to support them.

When comparing the client base of the LEV (such as the electric bicycle) rental industry to the client base of the manual bicycle rentals the electric bicycle rental client tends to be far more the spur-of-the-moment decision makers. As such most electrical bicycle rental clients are usually away from home (either on vacation or on a business trip) and do not typically desire to rent such limited-use devices for an entire day. To which most business trips or vacations do not take the electric bike rental clientele to the typical firm, fixed locations that rent electric bicycles and other such LEVs. This is primarily due to the fact that most tourist destinations lack of a continuous source of electricity by which to charge up the batteries of the electric bicycle and other personal LEVs.

There are numerous examples of solar and/or wind turbine powered shipping containers. U.S. 20060137348 A1 Mobile wind and solar energy aggregate details such a disclosure however it is for a mobile power station designed to supply power for other uses normally external to the power station. U.S. Pat. No. 9,157,418 B2 Sustainable power supply unit for ISO containers also details such an arrangement however it is for a specific mounting system of the solar panels and wind turbines to the shipping container itself, not for the container as it is used. What none of these, or any other solar and/or wind powered shipping container disclosures cover is the exact intended use for this power and how it relates to a mobile, relocatable LEV rental outlet.

Accordingly, what is needed is an integrated system with which to supply the continuous source of electricity needed to charge and maintain of fleet of LEVs (such as electric bicycles) offered for hourly rentals through an LEV rental outlet, and the means to by which to ship and then deploy this LEV rental outlet to off-grid and remote locations. More specifically, the means by which to ship deploy the LEV outlet to locations typically frequented by electric bike (and other such electrically powered personal vehicles) rental clientele (such as tourists, business travelers and sight-seers).

### BRIEF SUMMARY OF THE INVENTION

The inventors recognized that bicycle and other manually operated personal mobility vehicles (such as the Pedal Car) rental services have proliferated over the last 20 years however Light Electric Vehicles (LEVs) (such as electrically powered bicycles, Segways, Personal Mobility Scooters and other small electric 4-wheeled vehicles [such as a golf cart]) rentals have not. This lack of rental opportunities for LEVs can be attributed to several unique circumstances that, when all taken into account, shows that the business model for this market is only viable or profitable when necessary concessions are accounted for. In particular: a readily available source of electricity with which to charge up the batteries used by the LEVs. An embodiment of the invention provides for a self-contained, alternatively powered, mobile electrically powered LEV rental outlet than can be presented to the proper customer base at the proper time of year and be deployed in the proper location to be viable and profitable.

In some embodiments, the LEV rental outlet (herein referred to as rental outlet) is unique to the environment in which it is designed to operate in. Further, in some embodiments the location and environment in which the rental outlet is designed to be deployed is unique to the outlet itself.

An LEV rental outlet specifically configured to offer LEVs (such as the electric bicycle) contained herein to be available for rental on an hourly basis several times over the course of one day. This mobile rental outlet is configured from ISO Standard Shipping Containers (herein referred to as shipping container) for ease of transportation using conventional ocean-container shipping methods. This allows the rental unit to be deployed anywhere in the world.

The shipping container is equipped with a bank of batteries sized to provide the necessary amount of energy to charge up the batteries used in the LEVs being rented. This bank of batteries is charged with electricity provided though alternative means of power generation, usually photovoltaic solar panels and/or wind turbines.

The solar panels and/or wind turbines are attached to the shipping container in such manner that they can be readily removed and stowed within said shipping container for transportability. The solar panels and/or wind turbines are attached to the shipping container in such a manner that when removed from the exterior of the shipping container, the original design constraints and seaworthy certification of the shipping container remains intact.

The mobile rental outlet is configured so as to charge the LEV batteries used in the rental LEVs separately from the LEVs. This off-vehicle charging capability allows the rental outlet to rent each vehicle several times during the course of the business day by maintaining an electrical charge to one or more extra batteries for each LEV while it is being deployed. This feature in turn allows the LEVs to be rented out continuously over the course of several sorties without the need to set the vehicles aside to allow for recharging between sorties.

By being configured to charge up and deploy a fleet of one or more LEVs continually over the course of an entire business day in remote and/or off-grid locations this mobile LEV rental outlet is specifically configured to be deployed in locations served by the tourist industry, such as islands, beach resorts, national parks and other such locations that normally do not have access to, or allow the permanent infrastructure required for the rental outlet to have access to the electricity needed to offer such a rental service.

In one aspect, the invention relates to a mobile, alternatively powered LEV rental outlet. The outlet is specifically configured to be mobile and deployed by commercial carrier by being constructed in a ISO standard, seaworthy certified, ocean-going cargo container, has solar panels and/or wind turbines to charge batteries used on the electric bicycles, an energy storage device, and a plurality of LEV battery charging stations.

In another aspect, the invention relates to a business method of operating an LEV rental outlet. According to the business method disclosed herein the LEV rental outlet is placed using standard, commercially viable means in a remote, off-grid locations, locations that would not normally be able to support such an LEV rental business.

### BRIEF DESCRIPTION OF THE DRAWINGS

The invention and embodiments thereof will be better understood when the following detailed description is read in conjunction with the accompanying drawing figures. In these figures, key elements are not necessarily drawn to scale, in exacting location or in exact configuration. For the purpose of simplicity, the Light Electric Vehicles (LEVs) shown in these drawings and figures are shown as electric bicycles. In general, like key elements appearing in multiple figures are identified by a like reference designation. The invention can be best understood by those having ordinary skill in the art by reference to the following detailed description when considered in conjunction with the accompanying drawings in which:

FIG. 1 is a sketch of an enclosed LEV rental outlet with doors open to reveal the contents herein;

FIG. 2 is an exploded view of FIG. 1 less several walls, doors and several key elements from FIG. 1;

FIG. 3 is a sketch of an ISO Standard Shipping Container;

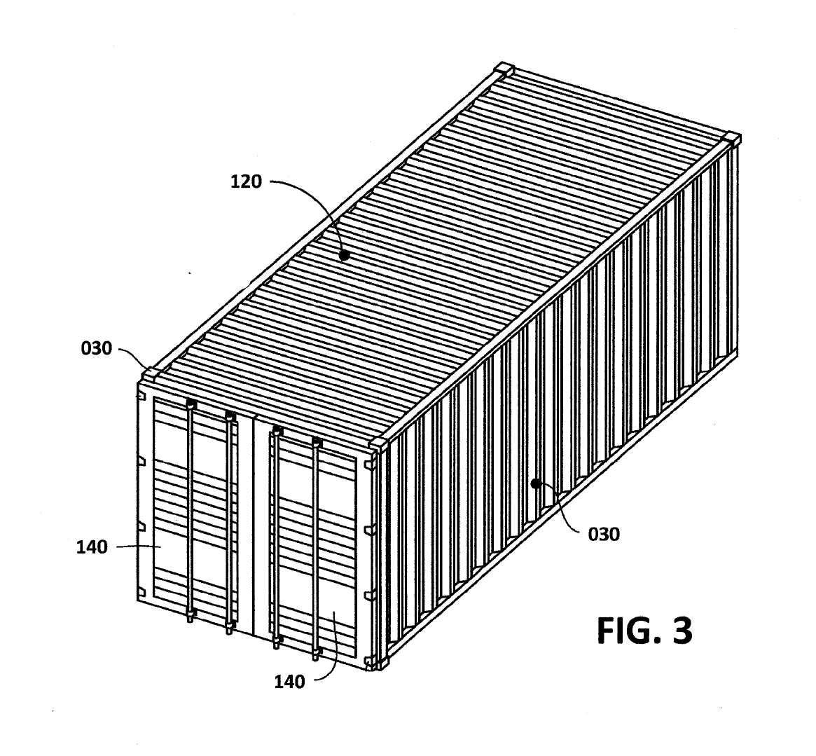

FIG. 4 is an exploded view of an ISO Standard Shipping Container showing one or more of key elements from FIG. 1 contained herein; and

FIG. 5 is a sketch of typical commercial container ship laden with ISO Standard Shipping Containers for transport.

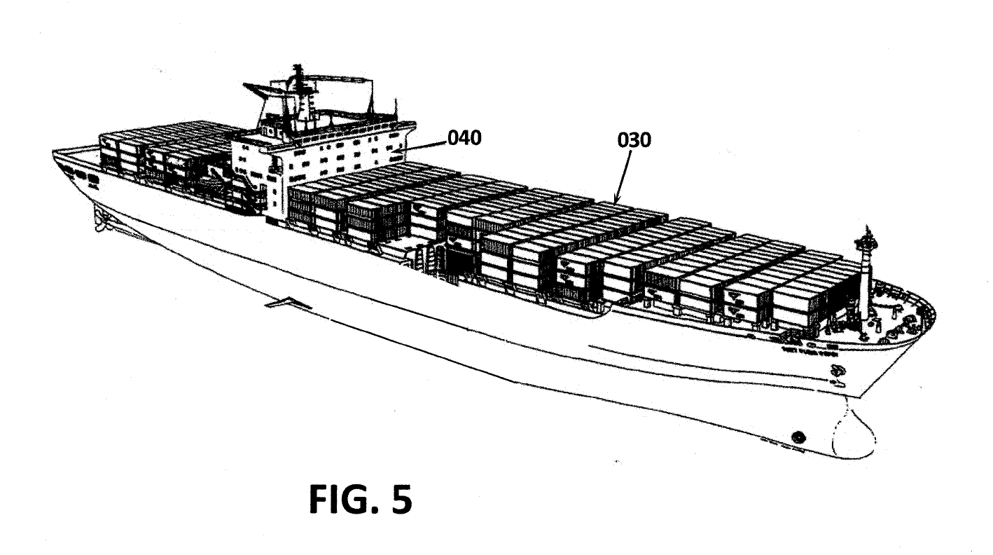

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

An Light Electric Vehicle (LEV) 010 (herein shown as an electric bicycle 010) rental outlet 020 specifically configured to offer the LEVs 010 contained herein to be available for rental on an hourly basis from rental outlet 020. This rental outlet 020 is configured from International Standards Organization [ISO] Standard Shipping Container 030 (herein referred to as shipping container 030) so as to be mobile for ease of transportation on commercial container ship 040. This allows the rental outlet 020 to be deployed anywhere in the world.

The rental outlet 020 is configured to charge the batteries 050 used by LEV 010 separately from the LEV 010 by means of separate battery charging station 060 (herein referred to as charging station 060). The batteries 050 used by the LEV 010 are typically removable so as to be charged separately in charging station 060. After the batteries 050 are charged they are then typically affixed to the LEV 010 in (or on) non-descript mounting bracket 180. It is understood by anyone familiar with the art of LEV 010 battery 050 charging that location and means to charge a plurality of batteries 050 as depicted in this disclosure do not limit the discloser from other means not depicted, and that batteries 050 may be left on LEV 010 non-descript mounting bracket 180 during charge and that scope of this disclosure is not limited by the depiction of removing batteries 050 from LEV 010 non-descript mounting bracket 180 during charge.

Charging station 060 is provided with electricity though alternative means of electrical power generation, usually photovoltaic solar panels 090 and/or wind turbine 100, via common power transmission means 110. Charging station 060 is configured with a plurality of battery charging receptacles 070 used to charge batteries 050 for use on LEV 010. For the purpose of this description the configuration, quantity, location and general arrangement of the charging station 060 and battery charging receptacles 070 are shown in a limited, simplified view. It is understood by anyone familiar with the art of battery charging that size, location, quantity, connection and means to charge a plurality of batteries 050 as depicted in this disclosure do not limit the discloser from other means not depicted, and that scope of this disclosure is not limited by this depiction.

The rental outlet 020 contained in the shipping container 030 is equipped with a bank of batteries 080. The bank of batteries 080 are charged by photovoltaic solar panels 090 and/or wind turbines 100 via common power transmission means 110. The bank of batteries 080 is sized appropriately to provide the necessary amount of electrical energy to charge up the batteries 050 used by the LEV 010 via charging station 060 when photovoltaic solar panels 090 and/or wind turbine 100 do not provide electrical power to charging station 060. It is understood by anyone familiar with the means by which to transmit electricity that the electrical transmission means 110 as depicted in this disclosure do not limit the discloser from other means of electrical transmission not depicted and that scope of this disclosure is not limited by this depiction.

The solar panels 090 and/or wind turbine 100 are typically attached to the shipping container 030 on shipping container roof 120 by non-descript, non-permanent mechanical means 130 such that solar panels 090 and/or wind turbine 100 can be removed from shipping container 030 in such a means as to maintain the original design constraints and structure of the shipping container 030 for transportation on commercial container ship 040. It is understood by anyone familiar with any mechanical means by which to attached solar panels 090 and/or wind turbine 100 to a shipping container 030 on shipping container roof 120, or any other part of shipping container 030 structure not depicted herein, that the depiction of said attachment in this disclosure does not limit the discloser from other mechanical means 130 of attachment to shipping container 030 not depicted herein, and that scope of this disclosure is not limited by this depiction, only that mechanical means 130 of attachment of solar panels 090 and/or wind turbine 100 to shipping container 030 on shipping container roof 120, or any other portion of shipping container 030, does not alter shipping container 030 in such a manner so as to make shipping container 030 no longer seaworthy and no longer transportable on commercial container ship 040.

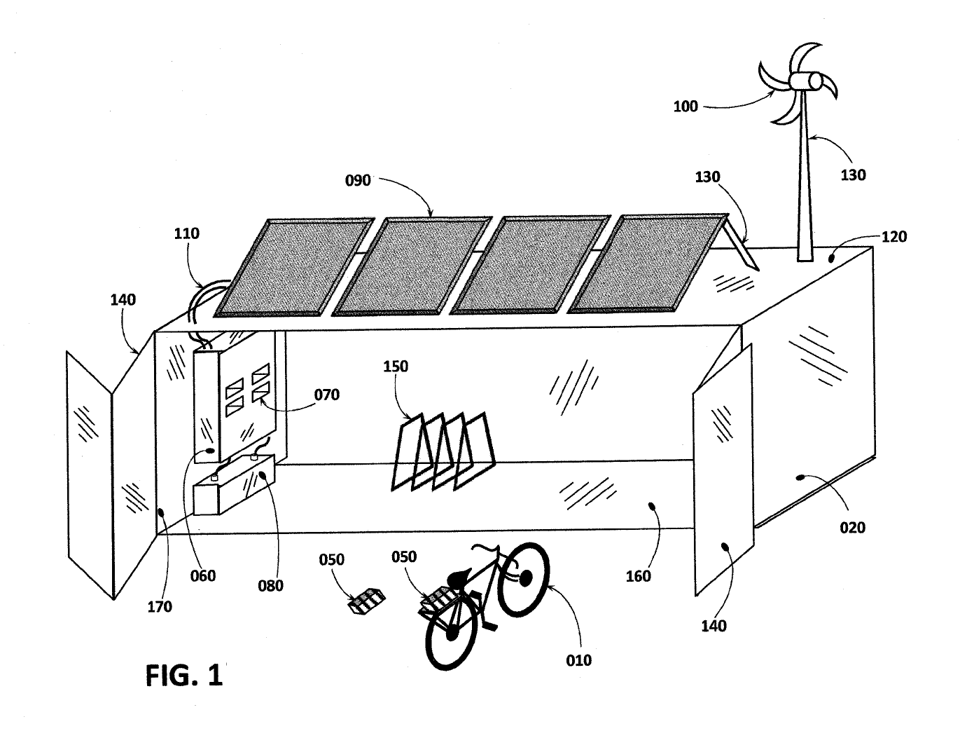

FIG. 1 shows doors 140 on rental outlet 020 configured along the longitudinal axis of rental outlet 020 however it is understood by anyone familiar with the configuration of shipping container 030 that doors 140 can and do come configured on all sides of shipping container 030 and that the doors 140 configuration as depicted in this disclosure do not limit size, number, location or operation of doors 140 on shipping container 030 from other configurations not depicted herein and that the scope of this disclosure is not limited by this depiction.

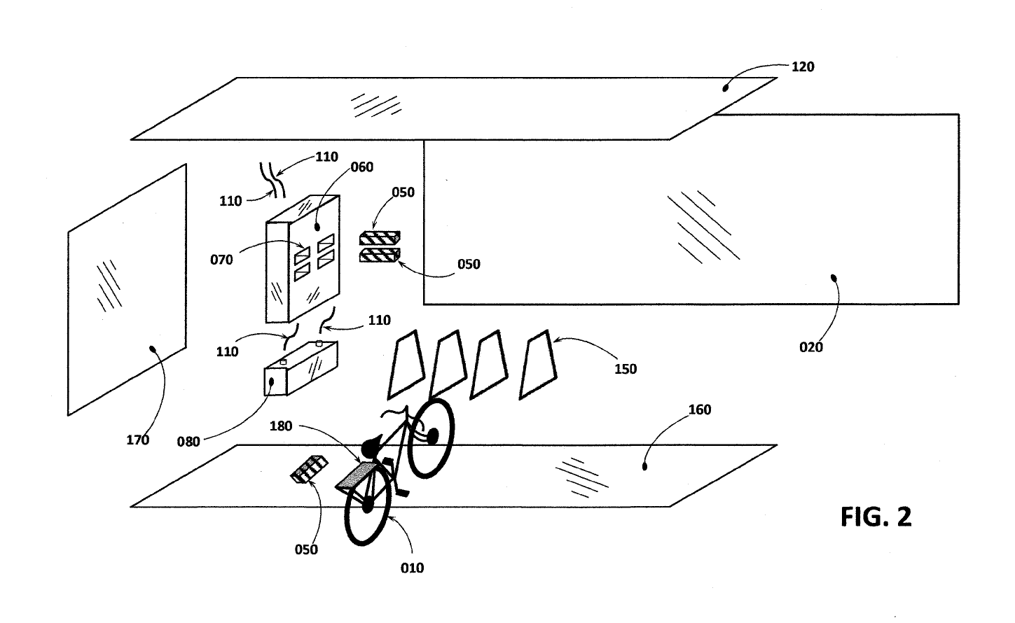

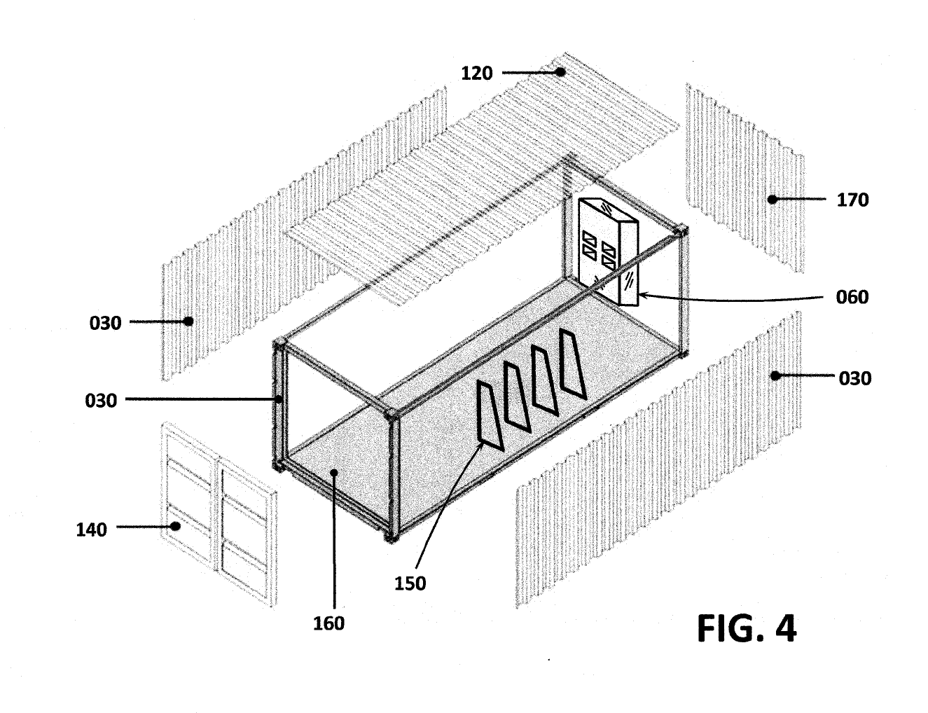

FIG. 1, enclosed LEV 010 rental outlet 020, FIG. 2, exploded view of rental outlet 020 and FIG. 4, exploded view of shipping container 030 detail approximate locations of key elements LEV rack 150 on shipping container floor 160, bank of batteries 080 on shipping container floor 160, and charging station 060 on shipping container wall 170 in relation to interior of shipping container 030. It is understood by anyone familiar in the art of retail outlets and with the configuration of LEV 010 rental outlets 020 that locations of key elements LEV rack 150, bank of batteries 080 and charging station 060 as depicted in this disclosure do not limit the size, quantity, location, orientation or operation of LEV rack 150, bank of batteries 080 and charging station 060 from other configurations common to the LEV 010 rental industry and that because other configurations of LEV rack 150, bank of batteries 080 and charging station 060 are not depicted in this disclosure that the scope of this disclosure is not limited by this depiction.

What is claimed is:

1. A Light Electric Vehicle rental outlet comprising:
A plurality of Light Electric Vehicle docks;
A plurality of portable battery charging stations;
An electrical energy storage device;
A photovoltaic solar array;
A wind turbine generator;
And a mobile enclosure;

2. The Light Electric Vehicle rental outlet of claim 1, wherein the said photovoltaic solar array is attached to said mobile enclosure for the purpose of providing electric power to said battery charging stations.

3. The Light Electric Vehicle rental outlet of claim 1, wherein the said wind turbine generator is attached to said mobile enclosure for the purpose of providing electric power to said battery charging stations.

4. The Light Electric Vehicle rental outlet of claim 1, wherein the said electrical energy storage device is used to store electric power generated from said photovoltaic solar array and said wind turbine generator.

5. The Light Electric Vehicle rental outlet of claim 4, wherein the said electrical energy storage device is used to provide electricity to said battery charging stations when said photovoltaic solar array and said wind turbine generator are not generating electricity.

6. The Light Electric Vehicle rental outlet of claim 1, wherein the said photovoltaic solar array, said wind generator, said battery charging stations, said Light Electric Vehicle docks, and said electrical storage device can be contained within the confines of said mobile enclosure.

7. An Light Electric Vehicle rental outlet operated from within a mobile enclosure comprising:
A plurality of Light Electric Vehicle docks;
A plurality of portable battery charging stations;
An electrical energy storage device;
A photovoltaic solar array;
A wind turbine generator;
And a mobile enclosure comprised from an International Standards Organization (ISO) Standard Shipping Container.

8. The Light Electric Vehicle rental outlet of claim 7, wherein the said photovoltaic solar array is attached to said mobile enclosure for the purpose of providing electric power to said battery charging stations.

9. The Light Electric Vehicle rental outlet of claim 7, wherein the said wind turbine generator is attached to said mobile enclosure for the purpose of providing electric power to said battery charging stations.

10. The Light Electric Vehicle rental outlet of claim 7, wherein the said electrical energy storage device is used to store electric power generated from said photovoltaic solar array and said wind turbine generator.

11. The Light Electric Vehicle rental outlet of claim 7, wherein the said electrical energy storage device is used to provide electricity to said battery charging stations when said photovoltaic solar array and said wind turbine generator are not generating electricity.

12. The Light Electric Vehicle rental outlet of claim 7, wherein said Light Electric Vehicle rack, said battery charging stations, said photovoltaic solar array and said wind turbine generator can be contained within the confines of said ISO Standard Shipping Container.

13. An Light Electric Vehicle rental outlet capable of being transported on commercial cargo container shipping vessels comprising:
A plurality of Light Electric Vehicle docks;
A plurality of portable battery charging stations;
An electrical energy storage device;
A photovoltaic solar array;
A wind turbine generator;
A mobile enclosure comprised from an ISO Standard Shipping Container;
And an ISO Standard Shipping Container sustainable to be transported on a commercial container ship.

14. The Light Electric Vehicle rental outlet of claim 13, wherein the said photovoltaic solar array is attached to said ISO Standard Shipping Container for the purpose of providing electric power to said battery charging stations.

15. The Light Electric Vehicle rental outlet of claim 13, wherein the said wind turbine generator is attached to said ISO Standard Shipping Container for the purpose of providing electric power to said battery charging stations.

16. The Light Electric Vehicle rental outlet of claim 13, wherein the said electrical energy storage device is used to store electric power generated from said photovoltaic solar array and said wind turbine generator.

17. The Light Electric Vehicle rental outlet of claim 13, wherein the said electrical energy storage device is used to provide electricity to said battery charging stations when said photovoltaic solar array and said wind turbine generator are not generating electricity.

18. The Light Electric Vehicle rental outlet of claim 13, wherein the said photovoltaic solar array and said wind turbine generator can be attached to the exterior of said ISO Standard Shipping Container.

19. The Light Electric Vehicle rental outlet of claim 13, wherein said Light Electric Vehicle rack, said battery charging stations, said photovoltaic solar array and said wind turbine generator can be contained within the confines said ISO Standard Shipping Container during transport on said commercial container ship.

20. The Light Electric Vehicle rental unit of claim 18, wherein said photovoltaic solar array and said wind generator can be removed from said ISO Standard Shipping Container in a manner that sustains said ISO Standard Shipping Container within ISO Standard Shipping Container Standards of seaworthiness for transport on said commercial container ship.
